(19) United States
(12) Patent Application Publication
(10) Pub. No.: US 2025/0260947 A1
(43) Pub. Date: Aug. 14, 2025

(54) PASSIVE RADIO FREQUENCY IDENTIFICATION WITH COMPUTER VISION TRACKING

(71) Applicant: Position Imaging, Inc., Portsmouth, NH (US)

(72) Inventors: Edward L. Hill, Conway, NH (US); Narasimhachary Nallana Chakravarty, Rollinsford, NH (US); Guohua Min, Exeter, NH (US)

(21) Appl. No.: 19/052,648

(22) Filed: Feb. 13, 2025

Related U.S. Application Data
(60) Provisional application No. 63/552,852, filed on Feb. 13, 2024.

(51) Int. Cl. H04W 4/029; G06T 7/70

(52) U.S. Cl. CPC H04W 4/029; G06T 7/70

(57) ABSTRACT

A tracking system comprises a radio communication system that utilizes radio waves from a mobile device comprising a microchip and antenna, the radio waves including information to register an identification of the mobile device and establish a position of the mobile device; a camera system that provides a field of view for surveying an area where the mobile device is located and in communication with the communication system; and a processing unit that processes the identification and location information of the mobile device received from the radio communication system and images received from the camera system in the field of view to associate location information of the mobile device tracked by the radio communication system with the images from the camera system to determine a position of the mobile device.

### RELATED APPLICATIONS

This application claims priority to U.S. provisional application No. 63/552,852, filed Feb. 13, 2024 and entitled “Passive Radio Frequency Identification with Computer Vision Tracking, the entirety of which is incorporated by reference herein.

### FIELD OF THE INVENTION

The invention relates generally to wireless tracking technology, and more specifically, to a combination of radio frequency and computer vision to track RFID objects.

### BACKGROUND

The tracking of objects, or more specifically the delivery of packages such as letters, containers, and boxes of any shape and size, entails complex logistics.

Most package shippers currently use barcode labels, tags, or the like on packages to track movement of the packages through their delivery system. Each barcode stores information about its package; such information may include the dimensions of the package, its weight and destination. When shipping personnel pick up a package, he or she scans the barcode to sort the package appropriately. The delivery system uses this scanned information to track movement of the package. Upon arriving at a final destination, a package rolls off a truck or plane on a roller belt. Personnel such as a delivery driver uses a barcode reader to scan the package, and the system recognizes that the package is at the destination.

Even at the final destination, there may be a desire to track assets such as delivered packages. Automation systems can identify what items a customer has taken from a shelf. Some systems employ video monitoring and image processing technology to identify those items. RFID (Radio Frequency Identification) chips on the packages can also be helpful in package tracking, but requires additional technology. It is desirable to use each technology's tracking information to achieve better visibility and identification of assets but without two disparate and hardware-intensive tracking systems.

### SUMMARY

In one aspect, a tracking system used to track the location of RFID labels comprising a radio communication system used to communicate with RFID label(s), to register RFID label ID and establish a position of the RFID label; a camera system surveying the area where the RFID label is located and in communication with the radio communication system; a processing unit that records the RFID label ID and location information from the radio communication system and uses that ID and location information with the images captured by the camera system to associate the location information of the RFID labels tracked by the radio communication system with the images captured by the camera to calculate a true position as determined by the camera system.

In some embodiments, the radio communication system uses received signal strength indicator (RSSI) to calculate the position of the RFID label. In some embodiments, the radio communication system uses Angle of Arrival (AoA) to determine the position of the RFID label. In some embodiments, the radio communication system uses Time of Arrival (TOA) or Time Difference of Arrival (TDOA) to determine the position of the RF label. In some embodiments, the camera system visually captures the RFID label or item that the RFID label is attached to and associates the images with the RFID location information as established by the radio communication system and to identify and track the RFID label as it moves within the camera field of view.

In another aspect, a tracking system comprises a radio communication system that utilizes radio waves from a mobile device comprising a microchip and antenna, the radio waves including information to register an identification of the mobile device and establish a position of the mobile device; a camera system that provides a field of view for surveying an area where the mobile device is located and in communication with the communication system; and a processing unit that processes the identification and location information of the mobile device received from the radio communication system and images received from the camera system in the field of view to associate location information of the mobile device tracked by the radio communication system with the images from the camera system to determine a position of the mobile device.

In another aspect, a tracking system for tracking a location of a plurality of mobile devices comprises a radio communication system; a camera system surveying the area where a mobile device of the plurality of mobile devices is located and in communication with the radio communication system; and a processing unit that records a unique, read-only identifier (UID) of the mobile device and location information of the mobile device from the radio communication system and uses the UID and location information with the images captured by the camera system to associate the location information of the mobile device tracked by the radio communication system with the images captured by the camera to calculate a true position as determined by the camera system.

In another aspect, a method for tracking a mobile device comprises positioning a mobile device on an object; associating the mobile device with the object; obtaining a position of the mobile device; capturing at least one image from a camera of the mobile device at the position; and associating the at least one image with information regarding the obtained position of the mobile device to identify the mobile device and track the mobile device as it moves within a field of view of the camera.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a flow diagram of a method for wireless tracking, in accordance with some embodiments.

FIG. 2 is a block diagram of a wireless tracking system, in accordance with some embodiments.

FIG. 3 is a schematic diagram of an environment in which some embodiments of the present inventive concept can be practiced.

FIG. 4 is a schematic diagram of an environment in which other embodiments of the present inventive concept can be practiced.

### DETAILED DESCRIPTION

In brief overview, the present inventive concept is based on utilizing two wireless tracking approaches, namely, radio tracking and computer vision, to track RFID labels that are placed on assets such as boxes, products, etc. inside buildings that may be used for retail, warehousing, production, etc. In particular, radio tracking is improved by computer vision for example, by using the radio tracking to determine a position, which is provided to a computer vision system. The ability to use each technology's tracking information to attain higher position data on passive RFIDs may benefit many industries that are trying to achieve better visibility of assets without expensive tags to be placed on the tracked items or expensive specialized computer vision cameras. Although RFID labels are referred to herein, any mobile electronic device (referred to generally as mobile devices) may equally apply. Such mobile devices such as RFID labels may be configured to have a unique identification number (UID), and the UID is registered by a radio communication system (also described herein) and used to establish an identity of the mobile device.

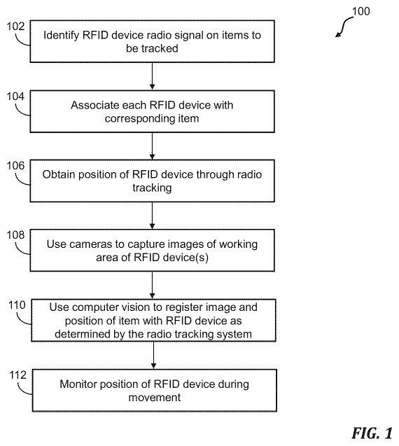

FIG. 1 is a flow diagram of a method 100 for wireless tracking in a facility, in accordance with some embodiments.

At step 102, RFID labels, tags, or other mobile electronic devices comprising passive RFID devices are positioned at or near items to be tracked. The RFID devices may include adhesives, mechanical pincers, straps, or other coupling elements for attaching the RFID devices to the items of interest.

At step 104, each RFID device UID, e.g., label, is registered by the radio tracking system, e.g., comprising RF nodes, beacons, antennas, and so on, and associated with the item it is in communication with, e.g., attached to. Because the RFID device or label is now in communication with, e.g., affixed to, the item, the item's movement and position can now be associated with the RFID label movement and this correlation can be used to track the RFID label movement and the item the label is attached to. Although an RF reader is referred to herein, the RF readers can be part of a node, which can include an RFID reader itself, but also encompasses other sensors or devices that might be connected to the network and interact with the RFID labels, tags, or the like. In some embodiments, the reader is fixed. In other embodiments, the reader is mobile but can be used in a manner similar to a fixed reader with the computer vision system identifying and tracking the position of the mobile reader. With the mobile reader's position determined by the computer vision system, it can then perform the same tracking function for RFID labels as a fixed reader in a known location. For example, a user may manually hold a mobile reader and the position of the mobile reader is established by the camera system “seeing” the mobile reader, e.g., capturing images of the reader in its field of view. The mobile reader position can also be acquired through the same RF to CV ID and position handoff. Subsequently, the system can determine where the reader is and the relative position data on each RFID label between the RFID reader and the RFID label. Knowing the true position of the mobile reader allows the system to track ID and position from the mobile reader even though it is not fixed. In this example, the system can establish where that mobile reader is located within the camera field of view (or within the tracking area). In registering the RFID device with the item, the RFID reader can detect the RFID device that contains the specific data stored within its memory, allowing the system to interpret this as a signal to initiate a registration process, such as recording information about the item to which the RFID device is associated.

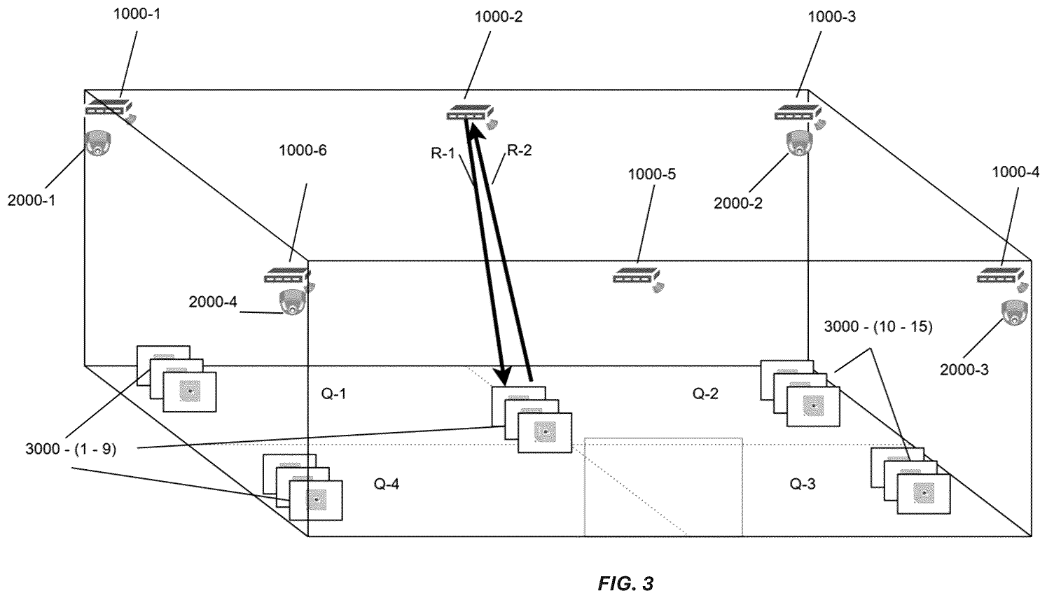

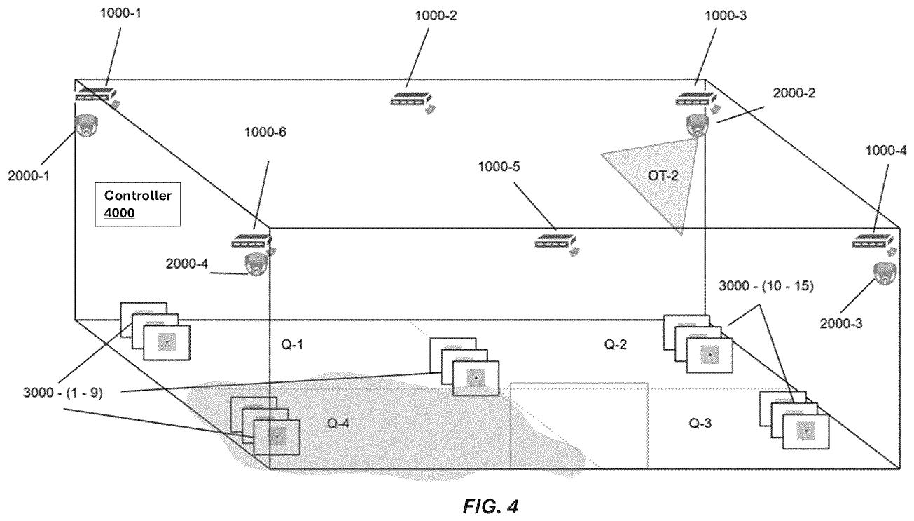

At step 106, once an RFID label is registered, the position of the label is obtained by using RFID readers (e.g., shown in FIGS. 3 and 4), placed around or used in the area that will be holding the assets with these RFIDs, to determine where in the facility the label is located. These readers initiate a radio signal that is received and reflected back by the RFID label to the fixed readers. The location information of these RFIDs labels can be determined from the RFID readers in a variety of ways, from signal strength at the receiving RFID readers to angle of arrival (AoA, or time of arrival (TOA) and through time difference of arrival (TDOA)) at multiple readers or a given reader's multiple antennae of the reflected signal sent from the RFID labels.

At step 108, once the position is established on these labels, a handoff of an RFID label position in the facility is then made to surveillance cameras in the facility. By using the image of the space and the individual items that move and are stored in the space, at step 110, the computer vision can register an image of an item in the space with an RFID device that was registered and tracked by the RFID readers, registering the image in the cameras field of view with the most likely RFID device correlated with that RFID device position in the image (correlated from the RFID label location information provided by the RFID readers). For example, estimated distance of each RF-transmitting device from each RF reader is used when assigning the identity of each RF-transmitting device to persons or objects of interest detected in the image. Once the RFID label position is established by the RFID readers and that location information is then handed off to the camera, at step 112, the camera can then continue to monitor the position of the RFID label as it moves and is “seen” by the camera, more specifically, the RFID device is in the camera's field of view and its movement and position are continually tracked by the camera system.

In embodiments where the location information on an RFID device achieved by the RFID readers is not accurate enough to successfully achieve a true position handoff or there are multiple RFID labels in the same area, the system can continue to track the location of the RFID device(s) with RFID readers until the camera can have a high level of confidence that the item in the image is the item registered and tracked by the RFID readers. As the items move throughout the facility, the corresponding RFID reader tracking will continue until there is enough fidelity of image position to RFID label location to make a confident association between RFID device and image(s) of the item (including the RFID device) in the image. Once the image is confidently associated with the RFID device, the computer vision system can continually track the item as it moves within the camera's field of view.

During system operation, the RFID readers will periodically broadcast to each of the RFID devices to ensure the items are still present and also to run its position detection routine to reinforce that the location information stored and registered by the computer vision camera system corresponds to the RFID label position information detected by the RFID readers.

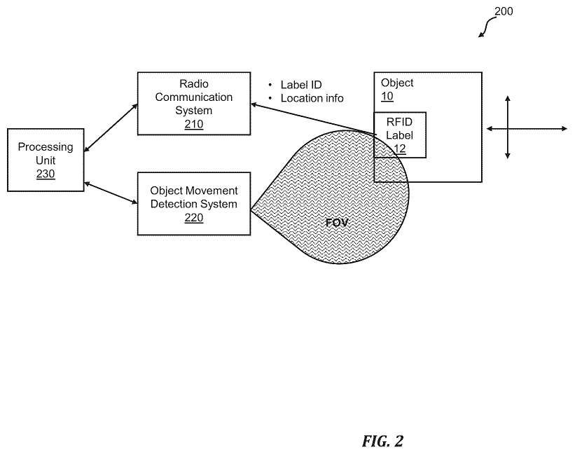

FIG. 2 is a block diagram of a wireless tracking system 200, in accordance with some embodiments. The wireless tracking system 200 may perform some or all of the method 100 of FIG. 1.

As shown, in some embodiments, the wireless tracking system 200 includes a radio communication system 210, an object movement detection system 220, and a special-purpose processing unit 230.

The radio communication system 210 may communicate with one or more RFID labels 12, or tags or related radio communication element or mobile electronic device, to register an RFID label identification (ID) and establish a position of the RFID label 12. As is well-known RFID labels 12 can have unique identifiers or “ID” codes associated with them, which are stored in an RFID computer chip embedded within the label 12. These ID codes are used to track and manage items 10, such as packages, etc., that have RFID labels 12 attached to them. The radio communication system 210 may include one or more RFID readers (e.g., shown in FIGS. 3 and 4) that can communicate with the processing unit 230 to register the RFID label's ID. In particular, the RFID reader can retrieve a unique identifier (UID) or the like embedded in the RFID chip of the label 12, which can be recorded by the processing unit 230 in an asset management or tracking system. The UID can be associated with a specific item, asset, or product in your system, which may include other details about the item 10 such as name, location, status, and any other relevant information about the item. The processing unit 230 can store the UID and associated item information in a database or other data repository for subsequent retrieval and tracking.

In addition to registering the label UID, the radio communication system 210 can establish a position of the RFID label 12, for example, using fixed readers placed around or in the area that will be holding the objects 10 with these RFID labels 12, to determine where in the facility the label 12 is located. These readers of the radio communication system 210 initiate a radio signal that is received and reflected back by the RFID label 12 to the fixed readers. The location information of these RFIDs labels can be determined from the RFID readers in a variety of ways, from signal strength at the receiving RFID readers, angle of arrival (AoA, or time of arrival (TOA) or time difference of arrival (TDOA)) of the reflected signal sent from the RFID labels 12.

The object movement detection system 220 includes a plurality of cameras or other sensors constructed and arranged to survey the area where the RFID label 12 is located and in communication with the radio communication system. The surveillance cameras can capture one or more images of the RFID label 12. The processing unit 230 can use the image of the space (shown as a field of view (FOV)) and the individual items 10 that move and are stored in the space to register the image(s) of the item 10 in the space with the RFID label 12 that was registered and tracked by the RFID readers 210. In particular, the processing unit 230 can register the image in the camera's FOV with the most likely RFID label 12 correlated with that image (correlated from the RFID label location information provided by the RFID readers). The recorded RFID label ID and location information from the radio communication system 210 and the images captured by the camera system 220 can be used to associate the location information of the RFID labels tracked by the radio communication system with the images captured by the camera and to calculate a true position as determined by the camera system 220. In some embodiments, this information can be used to recalibrate the 2D or 3D position of the RFID labels based on the image captured by the computer vision camera. This data can be used to screen against multipath and related signal interferers, using the known position of the RFID label as established by the camera system, to assist the radio communication system establish more accurate and stable radio-based tracking data by screening radio data that does not fit with the location data captured by the camera system. For example, when the radio communication system 210 uses RSSI or the like to determine the RFID label's position, the label 12 may have multiple possible distances away from the RF reader. The number of multiple signal paths (multipath) of transmitted signals from RFID labels (or other transmitting devices) could be in the hundreds. Determining range or, more specifically, the correct direct signal is a challenge, Using computer vision in this manner can help establish the position of the RFID label 12 and correlate that position with the most direct path signal, helping the system 200 cancel out the multipath signals that would normally imply multiple ranges of the RFID label 12 to the RF reader of the radio communication system 210.

FIG. 3 is a schematic diagram of an environment in which some embodiments of the present inventive concept can be practiced. The environment in FIG. 3 can include elements of the wireless tracking 200 and can execute some or all of the method 100 of FIG. 1.

In particular, the environment in FIG. 3 includes a plurality of RFID readers 1000, optical sensors, for example, cameras 2000 or the like, and RFID devices 3000 constructed and arranged as labels, tags, or the like. As shown in FIG. 3, in some embodiments, the RFID readers 1000 output a signal to the tracked RFID devices 3000 and receive a returned signed reflected by the RFID devices 3000 to calculate the location of the RFID devices 3000 in the environment.

In some embodiments, the location or position of the RFID devices can be determined by signal strength of the returned signal from the RFID devices. For example, an RFID reader 1000 can send an RF signal (e.g., R-1) to one or more RFID devices 3000. Each RFID device 3000 responds with a transmission of data including an identifier or the like. The RFID device 3000 transmits its response as a signal having a particular strength determined at least in part by the distance between the RFID device 3000 and the reader 1000. can be configured to determine a relative signal strength indicator (RSSI) value for the RF signals received from each RF-transmitting device. The RFID reader 1000 can measure its strength of the received signal, or RSSI. For example, the RFID reader 1000 includes a hardware and/or software component that measures the amplitude of the signal and communicates with a processing unit 4000, or controller or the like, that records the RSSI as a value (dBm) that reflects the strength of the signal. In some embodiments, the reader 1000 outputs to the processing unit 4000 the RSSI values as well as other information, such as the tag's unique identifier (UID) and other sensor data. The controller 4000 is configured to estimate a distance of each RF-transmitting device from each RF reader 1000 based on the RSSI values for the RF signals received by that RF reader 1000 from that RF-transmitting device and to use the estimated distance of each RF-transmitting device from each RF reader 1000 when assigning the identity of each RF-transmitting device to one of the plurality of humans detected in the image.

In some embodiments, the location or position of the RFID devices 3000 can be determined by angle of arrival received by a reader 1000. In some embodiments, the reader 100 has multiple antennas or antenna arrays to provide angle detection from the RFID devices 3000 so that the reader 1000 can receive signals from a device 3000, i.e., an RFID tag or the like, at different angles, wherein the antennas are capable of measuring the direction of the received signal. The difference in the time or phase of the signals received by each antenna allows the reader 1000 to calculate the direction from which the signal arrived. Using time-of-flight or phase shift measurements, the reader 1000 computes the AoA of the incoming signal.

In some embodiments, the RFID reader 1000 can calculate the phase difference between signals arriving at different antennas. Using this information, it can estimate the angle of arrival of the RFID device's signal, for example, with respect to the reader's position. By knowing the configuration of the antennas and the measured AoA, algorithms can be applied, for example, from the controller 4000 or stored in the reader 1000 to determine the direction from which the RFID device 3000 is located relative to the reader 1000. In some embodiments where there are multiple readers 1000, a position of an RFID device 3000 can be calculated by combining the AoA information from different perspectives with the algorithms. The information.

In some embodiments, the location or position of an RFID device 3000 can be determined by time of arrival (ToA)/time difference of arrival (TDoA) measurements. In particular, ToA refers to the exact moment when an RFID signal, transmitted by the RFID device 3000 reaches a specific reader 1000. By measuring the ToA at a given reader 1000, the system can estimate the distance from the RFID device 3000 to the reader 1000. The more readers 3000, the more precise the location of the device 3000 can be estimated, using triangulation or other techniques. TDoA refers to the measurement of the different in times in which an RFID signal is received at two or more different readers. This difference in arrival times at different readers can be used to calculate the relative position of the RFID device 3000 in relation to the multiple readers 3000. For example, when an RFID device 3000 emits a signal, the signal is picked up by multiple readers 1000 at different locations, and the difference in the times at which the signal reaches each reader 1000 can be used to triangulate the position of the device 3000. For example, if a first reader 1000 records the signal at 10 ms, and a second reader 1000 records it at 12 ms, the TDoA is 2 ms, which provides additional data to estimate distance differences between the readers 1000, allowing the position to be calculated.

As shown in FIG. 4, the optical sensor 2000-2, e.g., camera, provides a field of view (OT-2) focused on a particular area of the tracked volume (e.g., quadrant Q-4), or region at which the holding the RFID devices 3000 (1-9) are located. For example, the field of view (OT-2) includes is the “total” field of view of the camera and region (Q-4) is the region of interest. In some embodiments, all regions (Q1-Q4) are in the field of view (OT-2).

As the location of the RFID devices 3000 become known through the radio communication with the RFID readers 1000, the optical sensors 2000 will follow the movement of the RFID devices and compare the movement with the known location of the RFID devices, determined by the RFID readers 1000. In some embodiments, the optical sensors 2000, e.g., cameras are positioned on an apparatus such as a movable platform, for example, a gantry, swivel, etc. that permits the cameras to move in one or more degrees of freedom and in doing so the field of view can be changed to account for a movement of one or more RFID devices 3000 of interest. The field of views of the various cameras 2000 may be the same, albeit from different locations within the area being tracked. In some embodiments, each camera's image can be stitched with those of the other cameras to generate a single image reference where the RFID devices 3000 are tracked, i.e., sharing coordinates or positions with each camera 2000. As the RFID devices 3000 continue to move, their images are registered and, by using the continued position determined by the RFID readers 1000 to associate the items seen in the image (2000) with the items' position determined by the RFID readers 1000, the labels can be registered and tracked after and while the initial position of the RFID devices is determined by the RFID readers 1000. As used herein, registration refers to the identifier (ID) and position established by the cameras 2000 from the ID and position data received from the RFID readers 1000.

For example, as RFID items move throughout a facility and are tracked within the field of view and tracking area of the RFID reader, a camera 2000 captures its FOV images regarding the movement and will associate the movement with RFID tracking data it receives from the RFID readers 1000. Since the RFID readers 1000 are constantly identifying and tracking the RFID labels 3000, their movement (and position) as seen by the cameras is associated with the ID and tracking data received from the RFID readers and this association assists the cameras 2000, which may be part of a computer vision system, correlate or associate the position and movement with the RFID label position and movement as determined by the RFID readers. This tracking and “association” are constant. Consequently, the RFID readers are constantly confirming that movement in the image is the changing data it receives from these moving RFID labels.

As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure, or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all the described terms. Any references to front and back, left and right, top and bottom, upper and lower, inner, and outer, interior, and exterior, and vertical and horizontal are intended for convenience of description, not to limit the described systems and methods or their components to any one positional or spatial orientation. Accordingly, the foregoing description and drawings are by way of example only, and the scope of the invention should be determined from proper construction of the appended claims, and their equivalents.

As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure, or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

What is claimed is:

1. A tracking system, comprising:
a radio communication system that utilizes radio waves from a mobile device comprising a microchip and antenna, the radio waves including information to register an identification of the mobile device and establish a position of the mobile device;
a camera system that provides a field of view for surveying an area where the mobile device is located and in communication with the communication system; and
a processing unit that processes the identification and location information of the mobile device received from the radio communication system and images received from the camera system in the field of view to associate location information of the mobile device tracked by the radio communication system with the images from the camera system to determine a position of the mobile device.

2. The tracking system of claim 1, wherein the mobile device is a radiofrequency identification (RFID) label with a unique identification number (UID), and the UID is registered by the radio communication system and used to establish an identity of the RFID label.

3. The tracking system of claim 1, wherein the processor associates the images of the mobile device or an object to which the mobile device is attached from the camera system with the identity and location information provided by the radio communication system to identify and track the mobile device as it moves within the field of view of the camera.

4. A tracking system for tracking a location of a plurality of mobile devices, comprising:
a radio communication system;
a camera system surveying the area where a mobile device of the plurality of mobile devices is located and in communication with the radio communication system; and
a processing unit that records a unique, read-only identifier (UID) of the mobile device and location information of the mobile device from the radio communication system and uses the UID and location information with the images captured by the camera system to associate the location information of the mobile device tracked by the radio communication system with the images captured by the camera to calculate a true position as determined by the camera system.

5. The tracking system of claim 4, wherein the identification includes a label ID, and wherein the communication system communicates with the mobile device to register the label ID and establish a position of the mobile device.

6. The tracking system of claim 4, wherein the mobile device includes a radio frequency identification (RFID) label.

7. The tracking system of claim 4, wherein the radio communication system uses received signal strength indicator (RSSI) to calculate the position of the mobile device.

8. The tracking system of claim 4, wherein the radio communication system uses Angle of Arrival (AoA) to determine the position of the mobile device.

9. The tracking system of claim 4, where the radio communication system uses Time of Arrival (TOA) or Time Difference of Arrival (TDOA) to determine the position of the mobile device.

10. The tracking system of claim 4, wherein the camera system visually captures the image of the mobile device or item that the mobile device is attached to and associates the image with the location information as established by the radio communication system to identify and track the RFID label as it moves within the camera field of view.

11. A method for tracking a mobile device, comprising:
positioning a mobile device on an object;
associating the mobile device with the object;
obtaining a position of the mobile device;
capturing at least one image from a camera of the mobile device at the position; and
associating the at least one image with information regarding the obtained position of the mobile device to identify the mobile device and track the mobile device as it moves within a field of view of the camera.

12. The method of claim 11, wherein the mobile device includes a radio frequency identification (RFID) communication device.
